(19) United States
(12) Patent Application Publication
(10) Pub. No.: US 2011/0101034 A1
(43) Pub. Date: May 5, 2011

(54) FLUID DISPENSER CONTAINING A BAFFLE

(76) Inventors: Mary C. Baeten, De Pere, WI (US); John Paul Hogan, Little Suamico, WI (US); Michael Kevin Hogan, Green Bay, WI (US)

(21) Appl. No.: 12/611,507

(22) Filed: Nov. 3, 2009

(51) Int. Cl. B67D 7/58; B29C 49/20; B67D 7/78

(52) U.S. Cl. 222/377; 425/501; 222/382; 222/464.7

(57) ABSTRACT

A fluid dispenser and a mold used for manufacturing the fluid dispenser are disclosed. A baffle inside the fluid dispenser extends from an area on the bottom of the fluid dispenser toward a first side wall and away from a second opposite side wall forming an acute angle with the bottom. A gap between the baffle and the first side wall allows fluids to move freely from one side of the baffle to the other permitting emptying most of the residual fluid through a dip tube disposed into the bottom corner with the second side wall. The mold contains two cavities each disposed within a block configured to close over a molten plastic parison. Each cavity comprises a blade configured in a way that closing the mold produces the baffle inside the container.

### FIELD OF THE INVENTION

The present invention relates to a fluid dispenser. More specifically, the present invention relates to a baffle disposed at the bottom of the fluid dispenser that enables near complete dispensing of the residual fluid from the bottom of the fluid dispenser.

### BACKGROUND OF THE INVENTION

Bottles for dispensing fluids often contain a spray nozzle and a dip tube that reaches to the bottom of the fluid dispenser in order to draw out as much fluid as possible. Fluids dispensed by such bottles may include but are not limited to window cleaning solutions, water, perfumes, mouthwash and oils. However, a height between about 0.1″ to as much as about 0.25″ cannot be removed because the dip tube does not quite reach the bottom of the fluid dispenser. Also, an amount of residual fluid stays trapped inside the dip tube which cannot be drawn out when the bottle is empty.

The residual fluid in commonly used fluid dispensers such as spray bottles makes up from about 0.5% to as high as about 10% of the weight of the fluid in the bottles and presents both a consumer and an environmental problem. Small amounts of residual and potentially toxic fluid in each fluid dispenser multiplied by billions of such dispensers disposed in landfills every year potentially amounts to a significant toxic load to the environment. Also these residual fluids reduce the amount of useable product from which consumers may benefit.

A spray bottle configuration currently on the market offers a partial solution. With this configuration, the dip tube is bent to one side of the fluid dispenser and reaches to a corner where the bottom joins a side wall. This design is useful for spray bottles that require tilting downward in order to reach horizontal surfaces or spray bottles that may be used to spray in a downward tilt. When spraying in a downward tilt, the fluid accumulates in the corner where the lower end of the dip tube is placed thus leaving only a negligible amount of residual fluid. A disadvantage of this design is that the residual fluid may not be drawn out if the bottle is used for spraying in an upright position, which currently is the most common position that spray bottles are used, or spraying upward when the fluid is drawn down to a low level.

Various solutions to this problem are provided in prior art references. U.S. Pat. No. 4,470,526 discloses a dispensing container having a sloped bottom sidewall, into a lowermost portion of which, a feed tube is extended and connects to a dispensing spout on a top of the container. U.S. Pat. No. 5,366,119 teaches a bottle having a flat exterior base, a sidewall extending around said exterior base and projecting upwardly to terminate in a neck, and a sloped internal base which tapers from said sidewall. The exterior base is separate from the bottle. Similar designs of fluid dispensers having sloped bottom sidewalls are presented in U.S. Pat. Nos. 5,062,549, 6,257,446, 6,648,201, 6,752,297 and US Publication number 20060186144.

In order to maintain their original shape and base, the fluid dispensers described in these prior art references “fill in” the void created by having sloped sidewalls with solid material or void spaces inside the bottle. The material may be part of the fluid dispenser or a separate base for sitting the fluid dispenser onto. Some of these approaches have the disadvantage of increasing both manufacturing and disposal cost, and creating a detriment to the environment. Another disadvantage to some of these approaches is that part of the volume normally used for containing fluids is blocked off thus reducing the useful capacity of the bottle.

A solution provided in U.S. Pat. Nos. 5,279,450, 5,518,150 and 7,055,722 involves placing one or more partitions that form two or more chambers inside a bottle that allow keeping the fluid in and/or transferring the fluid into the chamber from which it is drawn out by the dip tube. A disadvantage of the bottles described in U.S. Pat. Nos. 5,279,450 and 5,518,150 is that the chamber containing the dip tube from which the fluid is drawn out is small and thus empties quickly. This requires frequent transfers of fluid from the larger chamber. Also the structure disclosed in these prior art references limits the extent spray bottle may be tilted downward before the fluid escapes out of the chamber having the dip tube. A disadvantage of the bottle described in U.S. Pat. No. 7,055,722 is having a complex set of baffles that is difficult to manufacture.

### SUMMARY OF THE PRESENT INVENTION

In one aspect of the present invention, a fluid dispenser comprises: an inner cavity for holding a fluid, said inner cavity being defined by a substantially flat bottom, a first side wall, a second side wall, a front side, a back side and an open top side, said bottom of the inner cavity and said first side wall defining a first junction, said bottom and said second side wall defining a second junction; and a baffle having inner walls and outer walls, said inner walls of the baffle being disposed in the inner cavity of the fluid dispenser, said baffle having a bottom end and a top end, said bottom end of the baffle being disposed onto an area on the bottom of the inner cavity, said baffle extending from the area on the bottom of the inner cavity toward the first side wall, said baffle forming an acute angle in relation to the bottom of the inner cavity in a direction extending toward the first side wall in a manner that the baffle divides the inner cavity into a first compartment and a second compartment, said first compartment being in communication with the second compartment and in a manner that the top end of the baffle is disposed at a distance from the first side wall of the container, said baffle traversing through the front side and the back side of the bottle in a direction substantially parallel with the first side wall and the second side wall.

In another aspect of the present invention, a mold for forming a container having a predetermined interior shape comprises: a first block having a front side; a second block having a front side, said front side of the second block being configured to superimpose over the front side of the first block in a closed position of the mold; a first cavity disposed within the first block, said cavity containing a back wall, a bottom, an inside portion, a front portion, a first side wall and a second side wall; a second cavity disposed within the second block, said cavity containing a back wall, a bottom, an inside portion, a front portion, a first side wall and a second side wall; a first blade having a bottom end, a top end, a thickness and a front edge, said front edge extending from the back wall of the first cavity into the front portion of the first cavity; and a second blade having a bottom end, a top end, a thickness and a front edge, said front edge extending from the back wall of the second cavity into the front portion of the second cavity.

These and other features, aspects and advantages of the present invention will become better understood with reference to the following drawings, description and claims.

### BRIEF DESCRIPTION OF THE DRAWINGS

FIG. 1 is a side view of one side of a fluid dispenser according to an embodiment of the present invention;

FIG. 1A is a side view of the other side of a fluid dispenser according to an embodiment of the present invention;

FIG. 2 is another side view of a fluid dispenser according to an embodiment of the present invention;

FIG. 3 is a cross sectional side view of a fluid dispenser according to an embodiment of the present invention;

FIG. 4 is a cross sectional side view of a fluid dispenser in use according to an embodiment of the present invention;

FIG. 5 is another cross sectional side view of a fluid dispenser in use according to an embodiment of the present invention;

FIG. 6 shows a mold for manufacturing a fluid dispenser according to an embodiment of the present invention; and

FIG. 7 is a bottom view of a fluid dispenser according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention relates to a fluid dispenser and more specifically to a spray bottle configured for spraying fluids using a spray nozzle. However, devices using plungers for dispensing thick fluids such as lotions and shampoos that are not suitable for spraying also fall within the scope of the present invention. In an embodiment of the present invention, the spray bottle has a substantially flat bottom, a front side, a back side, a first side wall, a second side wall and a top side that define the bottle inner cavity. The top side ends with a threaded neck onto which a spray head equipped with a spray nozzle is attached. A baffle extends from an area on the bottom of the spray bottle toward the first side wall and ends at some distance from this side wall in a manner that the baffle forms an acute angle with the bottom of the bottle inner cavity as it extends toward the first side wall. The size of the acute angle with the bottom may range from about 25 degrees to about 75 degrees and most typically from about 40 degrees to about 50 degrees depending on the type and size of the bottle. The shortest gap between the top end of the baffle and the first side wall which the top end of the baffle approaches may range from about 5 mm and to about half the distance between the first side wall and the second side wall depending on the shape and size of the bottle. Also in this embodiment of the present invention, a dip tube extends from the spray head and bends toward the second side wall which is positioned opposite to the first side wall. The dip tube ends in a corner of a junction between the second side wall and the bottom. The distance from the position of the bottom end of the baffle, and the second side wall of the bottle may range from about 5 mm to about half the distance between the first side wall and the second side wall depending on the shape and size of the bottle. In an embodiment of the present invention, the bottle side walls are narrower than the front side and back side and represent the width dimension of the bottle, while the front and back sides represent the length dimension of the bottle. Accordingly, the baffle traverses the width of the bottle.

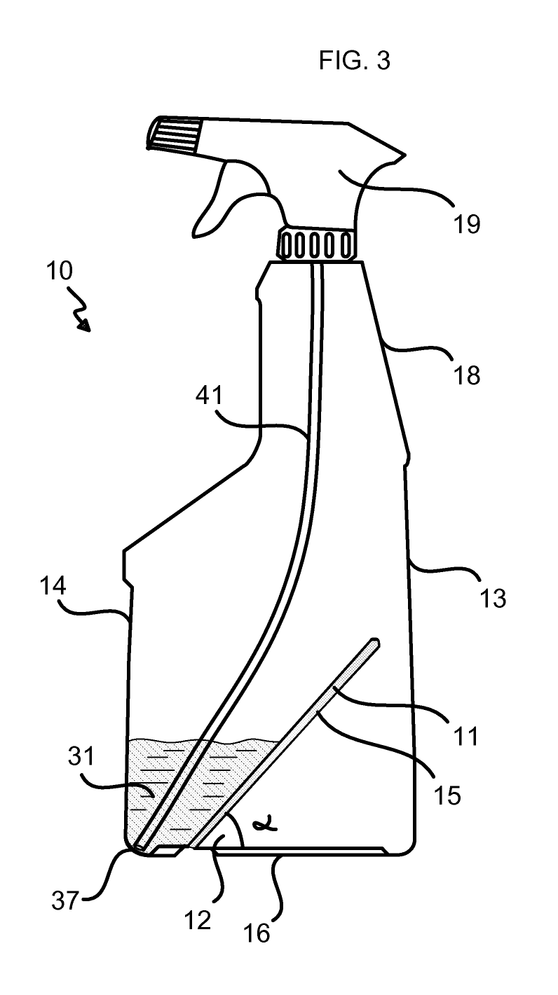

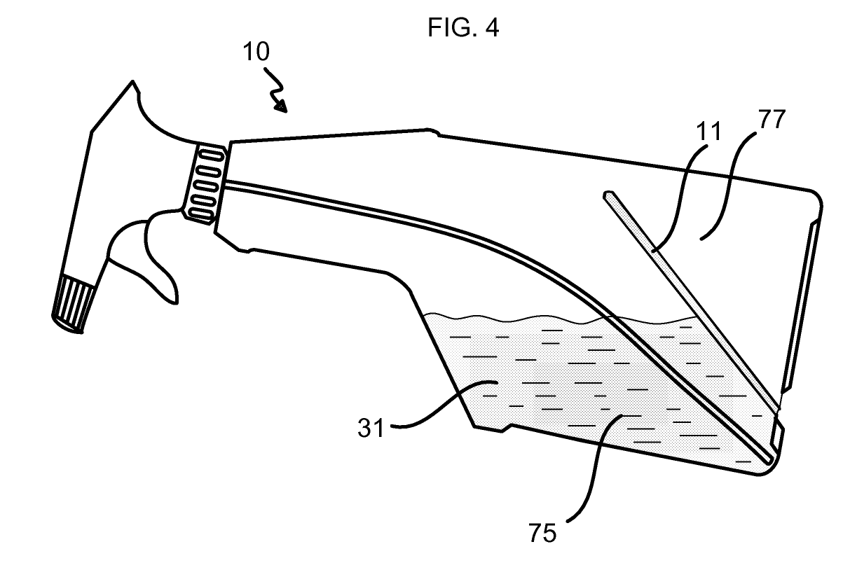

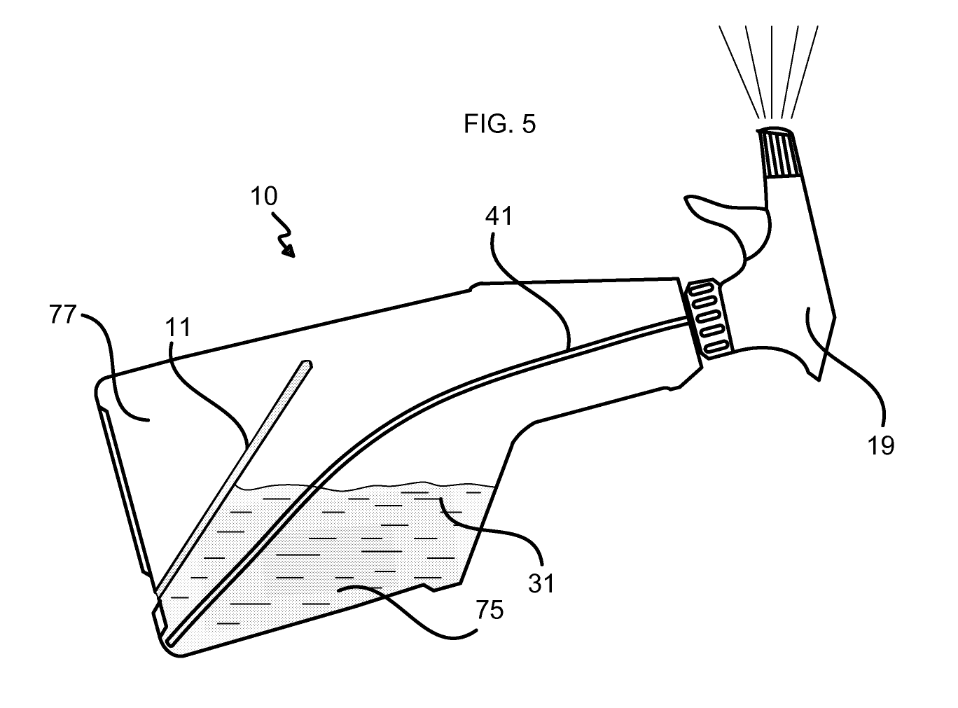

The bottle of the present invention has two compartments inside the bottle that are formed by the baffle: a first compartment between the baffle and the first side wall, and a second compartment between the baffle and the second side wall. In a typical use of this bottle, as the level of fluid dips below the top of the baffle, fluid resides inside both compartments. As the fluid level dips to a low level on the bottom of the bottle, the fluid may be transferred from the first compartment to the second compartment through the gap between the top of the baffle and the first side wall. This may be accomplished by inverting the bottle in a way that all the fluid gathers at the inverted top side of the bottle, tipping the bottom in a way that the fluid moves to the side of the second compartment and repositioning the bottle to its original position. The residual fluid will then gather at the junction between the bottom and the side wall of the second compartment where the bottom of the dip tube is positioned. With this configuration, most of the residual fluid may be drawn out in any spraying position: maintaining the bottle in the upright position as shown in FIG. 3, tipping the bottle for spraying downward as shown in FIG. 4 or tipping the bottle for spraying upward as shown in FIG. 5. In order to spray downward, the spray nozzle must be turned toward the second compartment. In order to spray upward, the spray nozzle must be turned toward the first compartment. The first compartment is generally smaller than the second compartment. As a result, only one transfer of the fluid from the first compartment to the second compartment is needed when the fluid level dips to a low level during use without overfilling the second compartment.

In an embodiment of the present invention, the baffle is formed by inserting a first blade through the front side of the inner cavity and a second blade through the back side of the inner cavity during the blow molding process used for forming the bottle from molten plastic. The insertion of the blades into the molten plastic results in pinching the plastic into a strip referred to as a weld that is wedged in a gap disposed in the outer walls of the baffle.

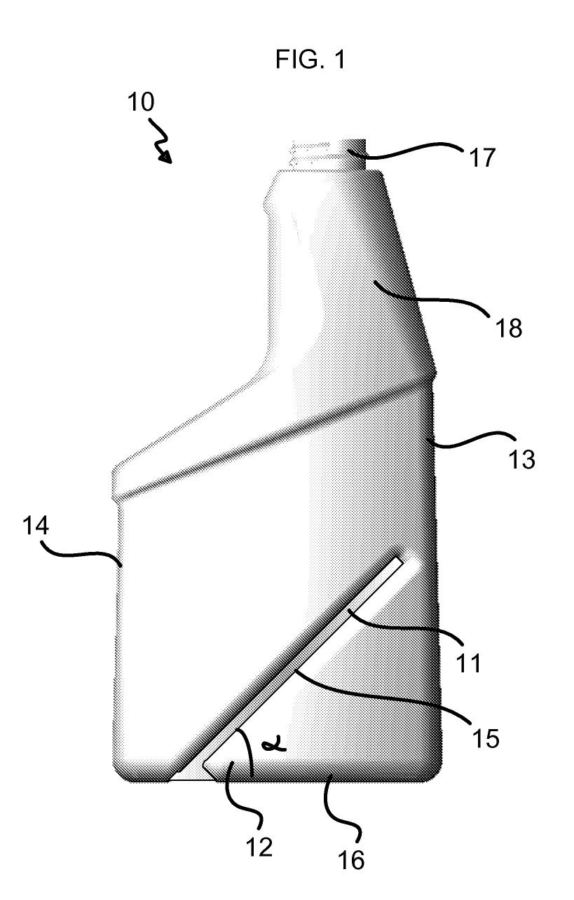

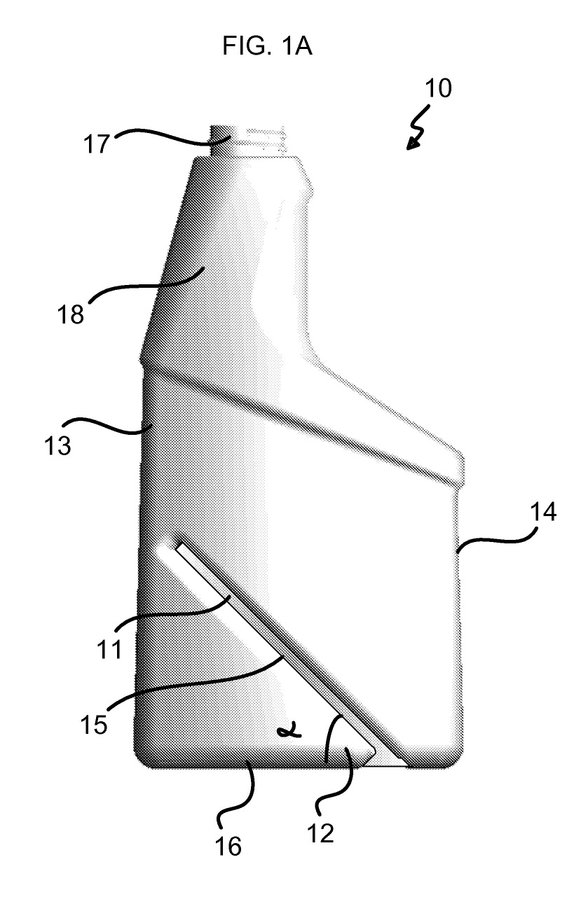

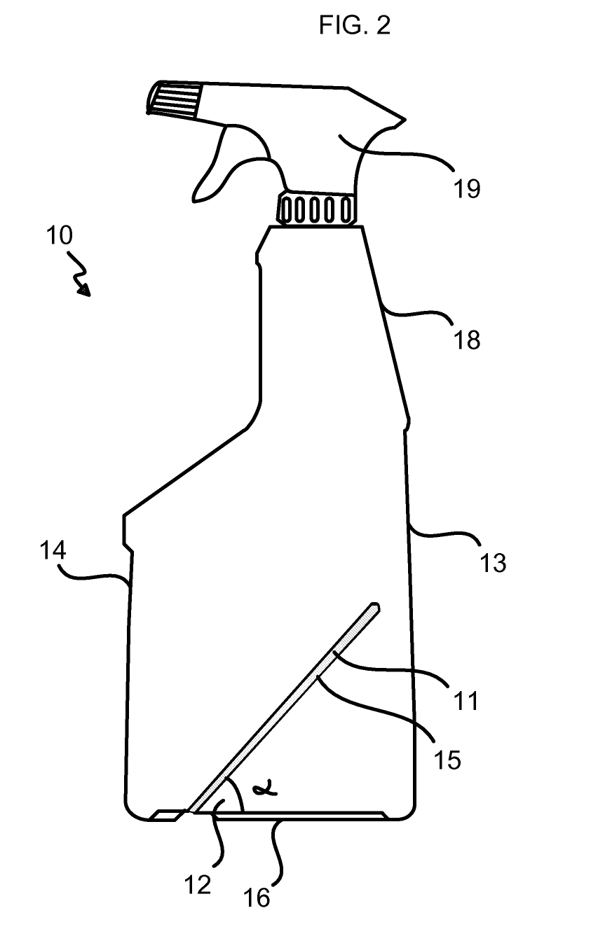

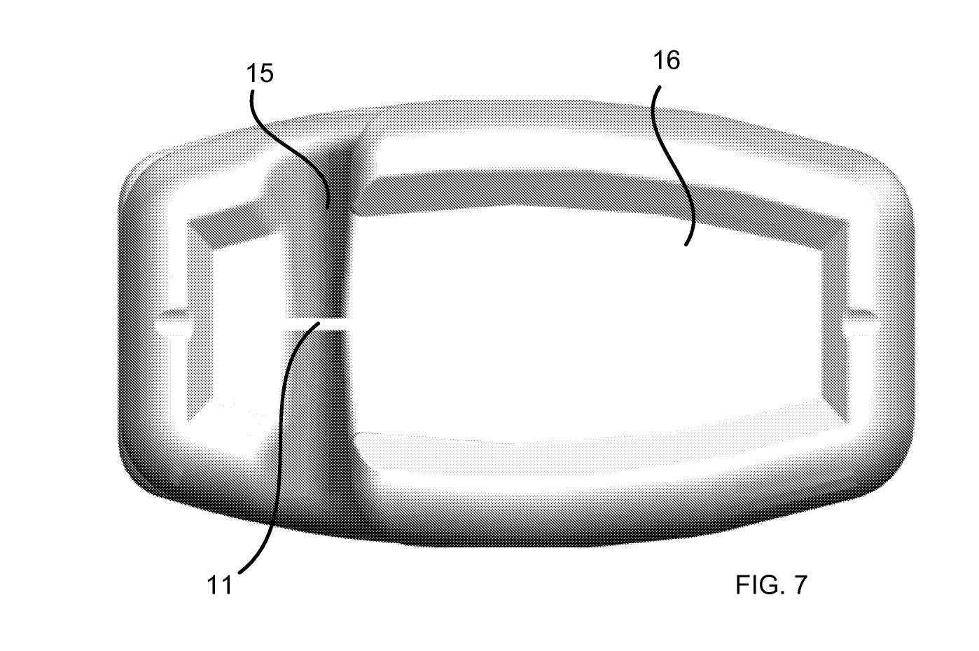

This embodiment of the present invention is illustrated in FIGS. 1-5 and FIG. 7. The bottle 10 contains a first side wall 13 which the top of baffle 15 approaches forming an acute angle 12, denoted by α, with the bottom of the bottle 16. The baffle sections the inner cavity of the bottle 10 into a first compartment 77 and a second compartment 75. The top of the bottle 18 narrows into a neck 17 onto which a sprayer head 19 is threaded. A dip tube 41 extends from the sprayer head 19 to the junction 37 between the bottom of the bottle 16 and the second side wall 14 that is opposite the first side wall 13. Fluid 31 is contained in the second compartment 75 irrespective of the spraying position as shown in FIGS. 3, 4 and 5. Outside the bottle 10, the baffle 15 appears as a slit in the bottle 10 on both sides as shown in FIGS. 1 and 7. The slit contains a plastic weld 11 positioned at about the middle of the slit in the width direction that results from the blow molding process.

The present invention also relates to a mold for making the fluid dispenser of the present invention in an extrusion blow molding process. In extrusion blow molding, plastic is melted and extruded into a hollow tube referred to as a parison. The parison is then captured by a cooled two-part metal mold which closes onto it. Air is blown into the parison inflating it into the shape of the fluid dispenser. After the plastic has cooled sufficiently, the mold is opened and the container is removed.

The mold of the present invention contains two sections. These sections may be mirror images of each other, fit together seamlessly and when brought together define an inner cavity. However, non-symmetrical molds and molds comprising of more than two sections also fall within the framework of the present invention.

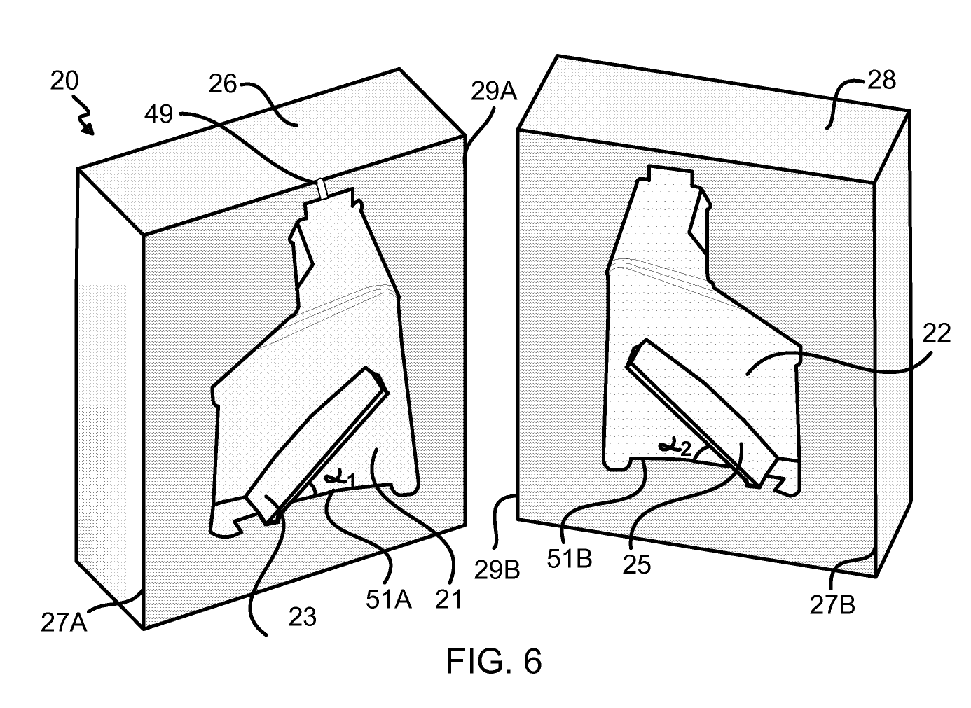

An embodiment of a mold 20 for manufacturing the container of the present invention is shown in FIG. 6. Shown are two blocks that contain two halves of a spray bottle: a first block 26 and a second block 28. The blocks have first front sides 29A and 29B and second front sides 27A and 27B. Sides 29A and 29B and sides 27A and 27B are configured to superimpose one over each other respectively when the blocks form a closed position. Each block contains a cavity 21 and 22 representing a longitudinal half of the bottle. Blades 23 and 25 extend from the back walls of cavities in the first block and second block 26 and 28 respectively into the front sides of the respective cavities 21 and 22 in a way that the front edges of the blades form a gap when the mold 20 is in the closed position. In the blow molding process of the bottle, a plastic weld is formed in the gap as the blades come close to each other around the parison. Air is blown into the parison through pin 49 after the mold closes onto the parison causing the parison to expand into the mold cavity and take the shape of the mold cavity. The parison is then cooled and removed from the mold. The thickness of the blades may vary from about 0.5 mm to about 5 mm depending on the type and size of the bottle. The gap formed between the blades and the thickness of the weld may also vary from about 0.5 mm to about 5 mm. The blades form acute angles with the respective cavity bottoms 51A and 51B as the blades and respective bottoms extend toward the joined front side of the blocks 29. The acute angles α₁ and α₂ may range from about 25 degrees to about 75 degrees and preferably from about 40 degrees to about 50 degrees.

A variety of polymers may be used for manufacturing the container of the present invention including, but not limited to, vinyl acetate, nylon, Polyethylene terephthalate, Polyvinyl chloride, Polyethylene, and Polypropylene. It is noted that the present invention is applicable to any shaped container bottom including, but not limited to, rectangular, elliptical and circular.

It should be understood, of course, that the foregoing relates to exemplary embodiments of the invention and that modifications may be made without departing from the spirit and scope of the invention as set forth in the following claims.

We claim:

1. A fluid dispenser comprising:
an inner cavity for holding a fluid, said inner cavity being defined by a substantially flat bottom, a first side wall, a second side wall, a front side, a back side and an open top side, said bottom of the inner cavity and said first side wall defining a first junction, said bottom and said second side wall defining a second junction; and
a baffle having inner walls and outer walls, said inner walls of the baffle being disposed in the inner cavity of the fluid dispenser, said baffle having a bottom end and a top end, said bottom end of the baffle being disposed onto an area on the bottom of the inner cavity, said baffle extending from the area on the bottom of the inner cavity toward the first side wall, said baffle forming an acute angle in relation to the bottom of the inner cavity in a direction extending toward the first side wall in a manner that the baffle divides the inner cavity into a first compartment and a second compartment, said first compartment being in communication with the second compartment and in a manner that the top end of the baffle is disposed at a distance from the first side wall of the container, said baffle traversing through the front side and the back side of the bottle in a direction substantially parallel with the first side wall and the second side wall.

2. The fluid dispenser of claim 1, wherein said baffle is formed by inserting a first blade through the front side of the inner cavity and a second blade through the back side of the inner cavity and wherein the first blade and second blade pinch a weld of plastic in a blow molding process.

3. The fluid dispenser of claim 1 further comprising a sprayer head attached to said top side, said sprayer head being adapted to turn toward the first side wall of the inner cavity, said sprayer head is also adapted to turn toward the second side wall of the inner cavity, said fluid dispenser further comprising a dip tube, said dip tube extending from the sprayer head to the second junction of the inner cavity.

4. The fluid dispenser of claim 1, wherein a distance between the bottom of the baffle and the second junction is in a range between about 5 millimeters to about half a distance between the first side wall and the second side wall.

5. The fluid dispenser of claim 1, wherein a distance between the top of the baffle and the first side wall is in a range between about 5 millimeters to about half a distance between the first side wall and the second side wall.

6. The fluid dispenser of claim 1, wherein a size of the acute angle ranges between about 25 degrees and 75 degrees.

7. The fluid dispenser of claim 7, wherein the size of the acute angle ranges between about 40 degrees and 50 degrees.

8. The fluid dispenser of claim 2, further comprising a weld wedged in the outer walls of the baffle.

9. A mold for forming a container having a predetermined interior shape comprising:
a first block having a front side;
a second block having a front side, said front side of the second block being configured to superimpose over the front side of the first block in a closed position of the mold;
a first cavity disposed within the first block, said cavity containing a back wall, a bottom, an inside portion, a front portion, a first side wall and a second side wall;
a second cavity disposed within the second block, said cavity containing a back wall, a bottom, an inside portion, a front portion, a first side wall and a second side wall;
a first blade having a bottom end, a top end, a thickness and a front edge, said front edge extending from the back wall of the first cavity into the front portion of the first cavity; and
a second blade having a bottom end, a top end, a thickness and a front edge, said front edge extending from the back wall of the second cavity into the front portion of the second cavity.

10. The mold of claim 9, wherein the first cavity includes a first portion of the interior shape of said container and the second cavity includes a second portion of the interior shape of said container.

11. The mold of claim 9 wherein the first cavity and the second cavity are adapted to close around a molten plastic parison in a blow molding process.

12. The mold of claim 11, wherein the front edge of the first blade and the front edge of the second blade define a predetermined gap in a closed position of the mold, said gap having a length ranging from about 0.5 mm to 5 mm.

13. The mold of claim 12, wherein the closed position of the mold around the parison is adapted to form a plastic weld disposed in the gap.

14. The mold of claim 9, wherein the bottom end of the first blade is disposed in an area on the bottom of the first cavity, said first blade extending from the bottom of the first cavity toward the first side wall of the first cavity, said first blade forming a first acute angle in relation to the bottom of the first cavity in a direction extending toward the first side wall of the first cavity, said top end of the first blade being disposed at a distance from the first side wall of the first cavity.

15. The mold of claim 9, wherein the bottom end of the second blade is disposed in an area on the bottom of the second cavity, said second blade extending from the bottom of the second cavity toward the first side wall of the second cavity, said second blade forming a second acute angle in relation to the bottom of the second cavity in a direction extending toward the first side wall of the second cavity, said top end of the second blade being disposed at a distance from the first side wall of the second cavity.

16. The mold of claim 14, wherein a size of the first acute angle ranges from about 25 degrees to about 75 degrees.

17. The mold of claim 15, wherein a size of the second acute angle ranges from about 25 degrees to about 75 degrees.

18. The mold of claim 16, wherein the size of the first acute angle ranges from about 40 degrees to about 50 degrees.

19. The mold of claim 17, wherein the size of the second acute angle ranges from about 40 degrees to about 50 degrees.

20. The mold of claim 9, wherein the thickness of the first blade and the thickness of the second blade each ranges from about 0.5 mm to about 5 mm.

21. The mold of claim 9, further comprising a pin for introducing air into the parison when the mold is in a closed position.
